(19) United States
(12) Patent Application Publication
(10) Pub. No.: US 2007/0253597 A1
(43) Pub. Date: Nov. 1, 2007

(54) Vehicular front environment detection apparatus and vehicular front lighting apparatus

(75) Inventors: Akira Utida, Okazaki-city (JP); Masayuki Imanishi, Okazaki-city (JP); Katsunori Michiyama, Toyota-city (JP); Atsushi Yamamoto, Nagoya-city (JP)

Correspondence Address: POSZ LAW GROUP, PLC, 12040 SOUTH LAKES DRIVE, SUITE 101, RESTON, VA, 20191, US

(73) Assignees: DENSO CORPORATION, Kariya-city (JP); NIPPON SOKEN, INC., Nishio-city (JP)

(21) Appl. No.: 11/723,430

(22) Filed: Mar. 20, 2007

(30) Foreign Application Priority Data
Apr. 26, 2006 (JP) 2006-122250

(51) Int. Cl. G06K 9/00

(52) U.S. Cl. 382/104

(57) ABSTRACT

A processor in a vehicle front environment detection apparatus processes an image from an imaging unit for detecting another vehicle based on the brightness of an environment of a traveling vehicle derived from the image. The detection result of the another vehicle is reflected to a control of at least one of headlamp selection and headlamp light distribution for the ease of headlamp control.

### CROSS REFERENCE TO RELATED APPLICATION

This application is based on and claims the benefit of priority of Japanese Patent Application No. 2006-122250 filed on Apr. 26, 2006, the disclosure of which is incorporated herein by reference.

### FIELD OF THE INVENTION

The present invention generally relates to a vehicular front environment detection apparatus and a vehicular front lighting apparatus.

### BACKGROUND INFORMATION

In recent years, a front lighting system for a vehicle is equipped with functions such as a lead vehicle detection and an oncoming vehicle detection in association with a front lighting control that controls high/low beams, lighting intensity and the like at night. In general, light intensity, or brightness, of a front light of the leading vehicle, is greatly different from that of a tail lamp of the oncoming vehicle, a streetlamp, or the like. Therefore, a uniform process for imaging and detecting all of those different light sources in a captured image has been difficult. Further, because the brightness of the light source is affected by a distance therefrom, it makes more difficult for distinguishing, for example, a distant tail lamp of the lead vehicle from a near headlamp of the oncoming vehicle, a streetlamp or the like.

Conventionally, a technique that employs two sets of optical filters and lenses for respectively responsive to the tail lamp of the lead vehicle and the headlamp of the oncoming vehicle to distinguish the vehicles in combination with high speed imaging for capturing flickering to distinguish the streetlamps is disclosed in a patent document. (Refer to Japanese patent document JP-A-2004-189229. The content of the patent document is also published as US patent document No. 2006/0177098.)

FIG. 9 shows an example of a schematic diagram of a conventional front lighting system. The conventional system includes two optical filters (a blue light filter 120 and a red light filter 121), two lenses (a lens 110, a lens 111) and imaging elements (an imaging element 100, an imaging element 101) for distinguishing the tail lamp of the lead vehicle and the headlamp of the oncoming vehicle. An image data is captured through a circuit 130 to an arithmetic processor (a CPU) for processes such as distinguishing the vehicles from the streetlamps based on high speed imaging that captures the streetlamp flickering hundred times per second and controlling a headlamp 160 through a lamp control unit 150.

Furthermore, another technique that employs two or more steps of exposure time of imaging input for image analysis is disclosed in Japanese patent document JP-A-2005-92857. (The content of the patent document is also published as US patent document No. 2005/0036660.)

However, the technique in Japanese patent document JP-A-2004-189229 has problems such as an increase of production cost due to a dual optical system with two imaging units, a requirement and plausibility of signal processing for handling high speed imaging data by a conventional imaging apparatus that is, for example, capable of 30 frames per second for NTSC standard.

Further, the technique in Japanese patent document JP-A-2005-92857 has problems such as a cost and process requirement of a highly sophisticated image analysis for extracting the lead vehicle and the oncoming vehicle in the captured image when the tail lamp of the lead vehicle and the headlamp of the oncoming vehicle are captured.

### SUMMARY OF THE INVENTION

In view of the above and other problems, the present invention provides a vehicular front environment detection apparatus and a vehicular front lighting apparatus that are capable of detecting vehicle with ease on demand.

The front environment detection apparatus for use in a subject vehicle includes an imaging unit for imaging a front view in a traveling direction of the subject vehicle, a light detector for detecting brightness of a field where the subject vehicle is traveling based on a processing of an image of the front view acquired by the imaging unit, and a field detector for detecting an other vehicle in the field based on the image of the front view when brightness of the field detected by the light detector is in a predetermined range. Further, as a front lighting apparatus, a headlamp controller for controlling a headlamp of the subject vehicle in terms of at least one of headlamp selection and headlamp lighting distribution based on a detection result of the light detector and the field detector is added to the front environment detection apparatus.

The front environment detection apparatus and the front lighting apparatus are capable of detecting the brightness of the field where the subject vehicle is traveling by the light detector, and thereby detecting another vehicle based on an image captured by the imaging unit. In this manner, detection of another vehicle is conducted for controlling the headlamp of the subject vehicle.

Further, the control of the headlamp is used to, for example, select a high beam and a low beam of the headlamp, and/or choose a light intensity of the headlamp.

The headlamp control may be varied according to various factors such as an averaged gradation level, the number of light sources, existence of an intensive light source, and the like in the image.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a front lighting apparatus in an embodiment of the present disclosure;

FIG. 2 shows a schematic diagram of the front lighting apparatus in the embodiment of the present disclosure;

FIG. 3 shows a flowchart of an analysis and control process of a headlamp of the front lighting apparatus;

FIGS. 4A to 4C show illustrations of a landscape, a captured image, and a processing of the captured image;

FIGS. 5A to 5C show other illustrations of a landscape, a captured image, and a processing of the captured image;

FIGS. 6A to 6C show yet other illustrations of a landscape, a captured image, and a processing of the captured image;

FIGS. 7A to 7C show yet other illustrations of a landscape, a captured image, and a processing of the captured image;

FIGS. 8A to 8C show yet other illustrations of a landscape, a captured image, and a processing of the captured image; and

FIG. 9 shows a schematic diagram of a conventional front lighting system.

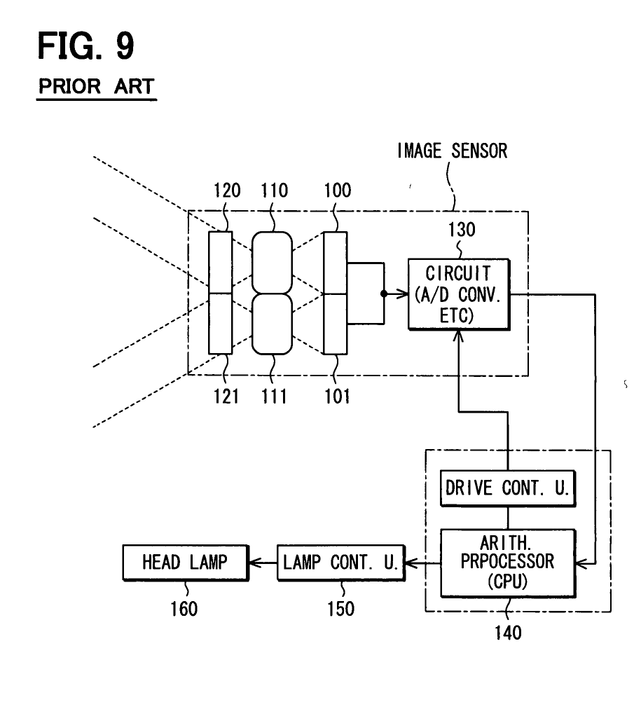

### DETAILED DESCRIPTION

An embodiment of the present invention will be described hereinbelow with reference to the drawings.

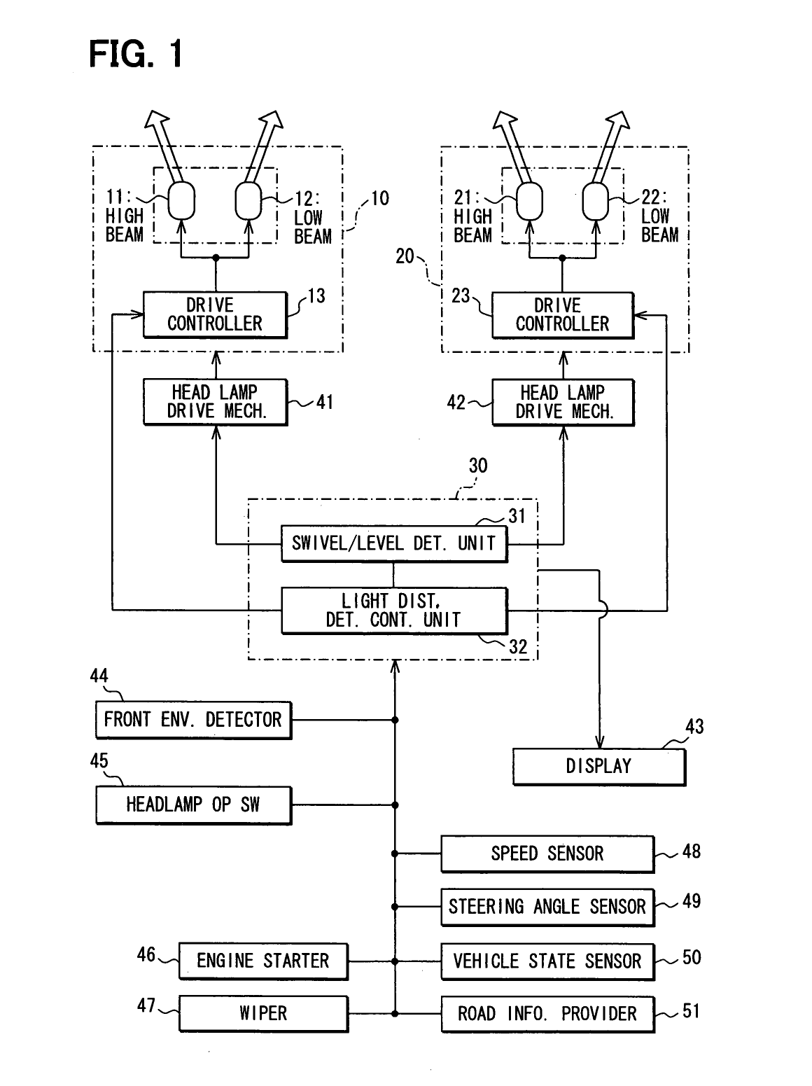

FIG. 1 shows a block diagram of a front lighting apparatus in an embodiment of the present disclosure.

The illuminating device for a vehicle has a left headlamp 10 and a right headlamp 20. The left headlamp 10 mounted on the left side of the front face of a vehicle illuminates the front left side of the vehicle, and includes a high-beam lamp 11, a low-beam lamp 12, and a drive controller 13. The high-beam lamp 11 is a lamp for a high beam, and the low-beam lamp 12 is a lamp for a low beam. The drive controller 13 drive-controls the high-beam lamp 11 and the low-beam lamp 12 (controls a lamp application voltage). Similarly, the right headlamp 20 mounted on the right side of the front face of the vehicle illuminates the front right side of the vehicle, and includes a high-beam lamp 21, a low-beam lamp 22, and a drive controller 23. The high-beam lamp 21 is a lamp for a high beam, and the low-beam lamp 22 is a lamp for a low beam. The drive controller 23 drive-controls the high-beam lamp 21 and the low-beam lamp 22 (controls a lamp application voltage).

The illuminating device for a vehicle has a headlamp controller 30. The headlamp controller 30 includes a light distribution determining/controlling unit 32 and a swivel/leveling determining unit 31.

Each of headlamp driving mechanisms 41 and 42 includes a leveling mechanism of adjusting the optical axis in the vertical direction and a swivel mechanism of varying an illumination range and direction by moving the optical axis or the headlamp itself in the horizontal direction. The headlamp driving mechanisms 41 and 42 are driven by a motor and the like. Switching and the like of the high-beam lamps 11 and 21 and the low-beam lamps 12 and 22 can be performed by controlling the drive controllers 13 and 23 of the headlamps 10 and 20 by using the headlamp controller 30 (the light distribution determining/controlling unit 32). By controlling the headlamp driving mechanisms 41 and 42 by using the headlamp controller 30 (the swivel/leveling determining unit 31), the adjustment of the optical axis in the vertical direction of the headlamps 10 and 20 by the leveling mechanism and the adjustment of the illumination range and direction by the swivel mechanism can be performed.

To the headlamp controller 30, a display 43, an in-vehicle front environment detector 44, a headlamp operating switch 45, an engine starter 46, a wiper device 47, a vehicle speed sensor 48, a steering angle sensor 49, a vehicle state sensor 50, and a road information provider (navigator) 51 are connected.

The display 43 is provided to notify the driver of the state of a headlamp presently used, and is disposed as an indicator in an instrument panel or the like.

The in-vehicle front environment detector 44 is an apparatus for determining vehicle front environment in the front field in the travel direction. The details will be described later.

The headlamp operating switch 45 is normally disposed near the steering wheel and can be manually operated by the driver. As operating modes, a light-out mode, a low-beam mode, a high-beam mode, and an automatic mode are provided. When the headlamp operating switch 45 is set in automatic mode, the in-vehicle front environment detector 44 is used.

The engine starter 46 outputs a start signal on start of the engine. The wiper device 47 outputs a wiping speed signal. The vehicle speed sensor 48 outputs a vehicle speed signal. The steering angle sensor 49 outputs a steering state signal. The vehicle state sensor 50 is a yaw rate sensor, an inclination sensor, or the like and outputs a vehicle state signal. The road information provider (navigator) 51 outputs an information signal of a road shape or the like. The headlamp controller 30 and the in-vehicle front environment detector 44 obtain those signals (the start signal, wiping speed signal, vehicle speed signal, steering state signal, vehicle state signal, navigation signal, and the like).

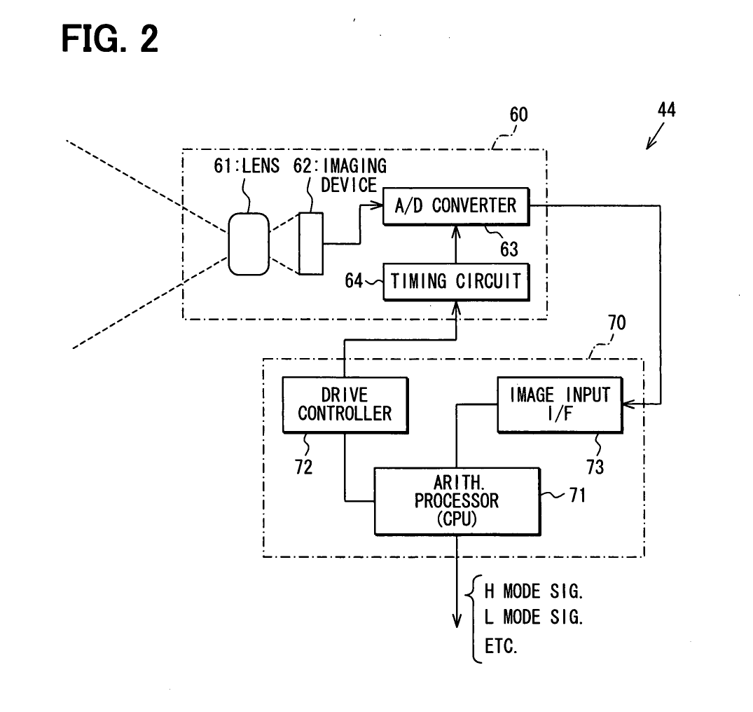

FIG. 2 shows a schematic diagram of the front lighting apparatus in the embodiment of the present disclosure.

In FIG. 2, the in-vehicle front environment detector 44 includes an image sensor unit 60 and a control circuit unit 70. The image sensor unit 60 is formed by an optical lens 61, an imaging device 62, an A/D converter 63, a timing circuit 64, and the like. The optical lens 61 and the imaging device 62 are mounted in the front portion of an inside rear view mirror. The imaging device 62 is formed by a CCD, a CMOS, and the like and obtains images in front of the vehicle in the travel direction via the optical lens 61. The A/D converter 63 converts (A/D converts) light received by the imaging device 62 to electric information. The timing circuit 64 outputs exposure time and charge information.

The control circuit unit 70 is formed by a drive controller 72, an image input interface (I/F) 73, and an arithmetic processor 71. The drive controller 72 drives the image sensor unit 60. The image input interface (I/F) 73 obtains an image subjected to A/D conversion performed by the A/D converter 63. The arithmetic processor 71 is formed mainly by a CPU and, when it is set in the automatic mode, performs a process of analyzing an image and controls the headlamps.

Next, the action of the illuminating device for a vehicle will be described.

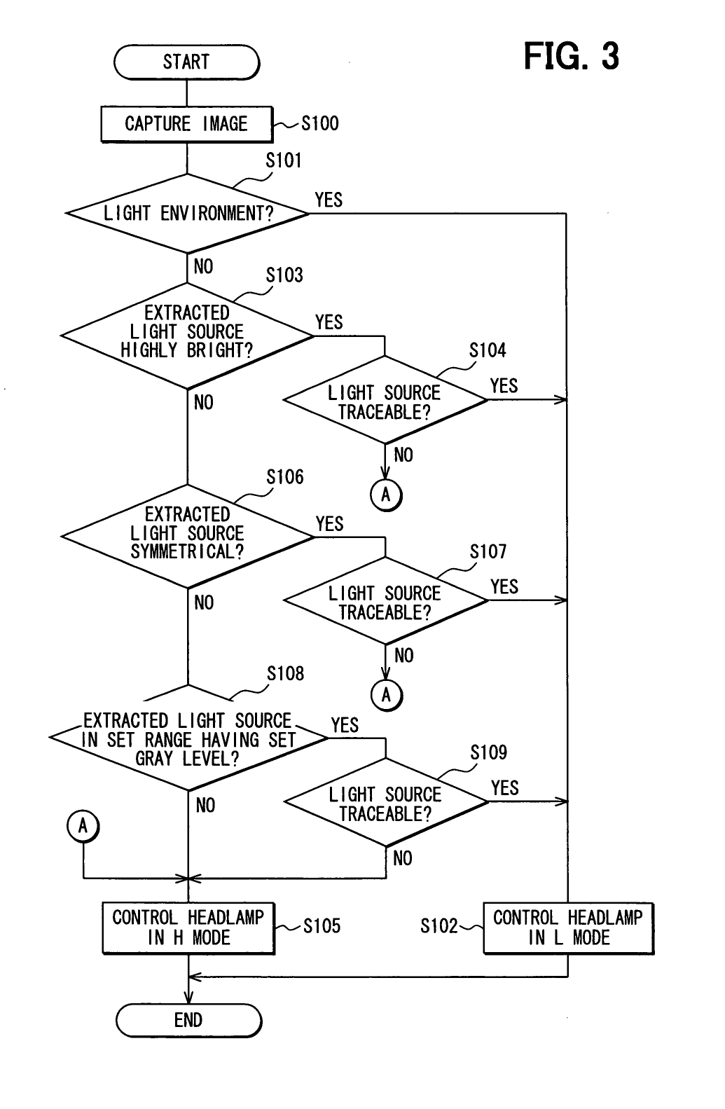

A signal for starting the image sensor unit 60 is output from the control circuit unit 70 in FIG. 2, an image of the front in the travel direction is captured by the image sensor unit 60, and an analyzing process and a headlamp control process are performed on the image by the arithmetic processor 71. The processes will be described with reference to the flow shown in FIG. 3.

In FIG. 3, the arithmetic processor (CPU) 71 captures an image in Step S100, and moves to Step S101. In Step S101, the arithmetic processor (CPU) 71 determines whether the ambient environment in which the vehicle travels is light or not. As a concrete determining condition, average gray level or the number of light sources in a pre-set range on an image is extracted and compared with a preset threshold value (determination value). In the case of a general monotone image of 256 levels, although it depends on sensitivity of the imaging device, the level of gray in a portion where there is no light source on the image is close to “0”, and the level of gray where there is a light source is according to the brightness of the light source.

In such a manner, the arithmetic processor (CPU) 71 processes the image obtained by the imaging device 62 and determines the brightness of the environment in which the vehicle travels. More specifically, an average level of gray in a preset range on a captured image of the front of the vehicle in the travel direction is calculated and compared with a preset gray-level value (threshold), thereby determining the brightness of the environment in which the vehicle travels. Alternatively, the number of light sources in a preset range on a captured image of the front of the vehicle in the travel direction is calculated and compared with a preset value (the number of light sources), thereby determining the brightness of the environment in which the vehicle travels.

The “preset range on an image” can be set in consideration of the parameters of the in-vehicle front environment detector (i.e., mount requirements such as mount height, angle of view, angle of depression, and the like), road conditions (i.e., road design basic requirements such as width of road, radius of curvature, and gradient), parameters of lightings on roads (i.e., basic requirements for mounting lightings on roads such as attachment height and intervals), and delineator parameters (i.e., basic requirements of mounting such as attachment height and intervals).

When a road light as a lighting on a road exists, the arithmetic processor (CPU) 71 determines that the travel environment is light in Step S101, moves to Step S102, and outputs a low-beam-mode signal (L mode sig. in FIG. 2). In response to the signal, illuminating operation is performed with the low-beam lamp (low beam is emitted) by the headlamp controller 30.

On the other hand, when the arithmetic processor (CPU) 71 determines that the travel environment is not light in Step S101, whether another high-brightness light source exists in the preset range on the image or not is determined in Step S103. A process of extracting a high-brightness light source is performed to extract a light source estimated as the light source of an oncoming vehicle at high probability in consideration of the relations that brightness of a tail lamp of a preceding vehicle is generally lower than that of a road light, and the brightness of a road light is generally lower than that of the headlamp of an oncoming vehicle. A high-brightness light source is a light source having gray level equal to or higher than a preset threshold value.

After the high-brightness light source is extracted in Step S103, the arithmetic processor (CPU) 71 moves to Step S104 and determines traceability. When the high-brightness light source has been traced for a predetermined period, the arithmetic processor (CPU) 71 determines that the light source is (the headlamp of) an oncoming vehicle.

In such a manner, the arithmetic processor (CPU) 71 extracts the light source of high brightness in the preset range on the captured image of the front of the vehicle in the travel direction and traces the light source, thereby determining the presence or absence of an oncoming vehicle. When it is determined that there is (the headlamp on an oncoming vehicle, the arithmetic processor (CPU) 71 moves to Step S102 and outputs the low-beam-mode signal. In response to the signal, illuminating operation is performed with the low-beam lamp (low beam is emitted) by the headlamp controller 30.

In Step S104, a determination is made in consideration of a movement change, a shape change, and the like of the high-brightness light source. The “movement” is considered on the basis of the fact that if the light source is an oncoming vehicle, the relative speed is high, so that the movement amount of the light source is large. The “shape change” is considered on the basis of the fact that if the light source is an oncoming vehicle, the vehicle approaches, so that the build of the light source gradually increases. When the change tendencies are different from the above, the light source is determined as ambient light.

When the light source is determined as ambient light by the determination of traceability in Step S104, the arithmetic processor (CPU) 71 moves to Step S105 and outputs a travel mode signal. In response to the signal, illuminating operation is performed with the high-beam lamp (high beam is emitted) by the headlamp controller 30.

When a high-bright light source is not extracted in Step S103, the arithmetic processor (CPU) 71 moves to Step S106, and determines whether or not a light source having symmetry exists in the horizontal direction in the preset range on the image. The operation is performed in consideration of the fact that the lightings of a vehicle are bilaterally symmetrical, and it is effective for determining whether the light source is the light source of a vehicle or not.

Specifically, when the vehicle width is set as 1.8 m and one side of a lighting of the vehicle is set as 0.2 m, the interval between the lightings of the vehicle is about seven times as wide as the build of the vehicle lighting. Consequently, the interval between the light sources which are symmetrical on the image is calculated, and whether the light source is a light source corresponding to the vehicle light or not is determined by comparing the calculated interval with an expected interval and comparing the build of the light source with an expected build. In addition, the symmetrical light sources having similar sizes are selected for the reason that even if the interval is an expected interval, the possibility that the light sources whose sizes are largely different from each other are ambient light is high.

When symmetrical light sources are extracted in Step S106, the arithmetic processor (CPU) 71 moves to Step S107 and determines traceability. When the symmetry is traced for predetermined time, the light sources are determined as those of a vehicle. The traceability is determined also in consideration of a change in the interval between symmetrical light sources, a change in build, a change in the brightness of the light source, a movement amount, a movement direction, and the like.

As described above, the arithmetic processor (CPU) 71 extracts light sources which are symmetrical in the horizontal direction in the preset range on the image of the front of the vehicle in the travel direction and traces the light sources, thereby determining the presence or absence of another vehicle. When the arithmetic processor (CPU) 71 determines that there is another vehicle (headlamp or tail lamp), the arithmetic processor (CPU) 71 moves to Step S102 and outputs a low-beam-mode signal. In response to the signal, illuminating operation is performed with the low-beam lamp (low beam is emitted) by the headlamp controller 30. When the light source is determined as ambient light from the determination of traceability, the arithmetic processor (CPU) 71 moves to Step S105 and outputs a high-beam-mode signal (H mode sig. in FIG. 2). In response to the signal, illumination is made with the high-beam lamp by the headlamp controller 30 (high beam is emitted).

On the other hand, when symmetrical light sources are not extracted in Step S106, the arithmetic processor (CPU) 71 moves to Step S108 and extracts a light source having preset gray level in a preset range on an image. The “preset gray level” denotes a gray level band having a range like a bandpass having the lower and upper limits. Specifically, the gray level band of a preceding vehicle is preset in consideration of the tendency that brightness of (tail lamp) of a preceding vehicle is lower than brightness of a road light, and the brightness of a road light is lower than that of (the headlamp of) an oncoming vehicle.

When the light source is extracted in Step S108, the arithmetic processor (CPU) 71 moves to Step S109 and determines traceability. The traceability is determined in consideration of a change in the build of the light source, a movement amount, a movement direction, and the like in a manner similar to Steps 104 and 107. When the light source has been traced for a predetermined period, the arithmetic processor (CPU) 71 determines that the light sources are those of a vehicle.

The trace time upon determination of the traceability of the extracted light source is predetermined time (continuous image frames) in which fluctuations in the light source position according to exposure time are considered. The time may be changed using, as elements, ups and downs in the road surface and the like. That is, the time of tracing the light source at the time of determining the presence or absence of a vehicle by tracing the light source may be changed on the basis of travel information (such as vehicle speed, steering angle, yaw rate, and inclination of the vehicle) of the vehicle (in a manner similar to Steps 104 and 107). Concretely, the time of tracing the light source is adjusted by using information indicative of the vehicle states from the vehicle speed sensor 48, the steering angle sensor 49, the vehicle state sensor 50, and the like. For example, when a vehicle travels at high speed, the light source trace time is shortened. The operation is preferable to optimize the light source trace time.

When a light source is not traced in predetermined time of tracing a light source at the time of determining the presence or absence of a vehicle by tracing a light source, the presence of a vehicle may be estimated on the basis of travel information (vehicle speed, steering angle, yaw rate, inclination of the vehicle, and the like) of the vehicle (in a manner similar to Steps 104 and S107). Concretely, even if a light source is not traced in predetermined time for tracing a light source, the presence of a vehicle is estimated by using information indicative of vehicle states from the vehicle speed sensor 48, the steering angle sensor 49, and the vehicle state sensor 50. It corresponds to, for example, the time when a vehicle travels at high speed or travels on a curved road. The operation is preferable to optimize the trace of the light source.

As described above, in Steps 108 and S109, the arithmetic processor (CPU) 71 extracts a light source having a preset gray level in a preset range on an image of the front of a vehicle in the travel direction, and traces the light source, thereby determining the presence or absence of another vehicle. When it is determined that another vehicle (headlamp or tail lamp) exists, the arithmetic processor (CPU) 71 moves to Step S102 and outputs a low-beam-mode signal. In response to the signal, illuminating operation is performed with the low-beam lamp (low beam is emitted) by the headlamp controller 30. When the light source is determined as ambient light from the determination of traceability and when no light source is extracted in Step S108, the arithmetic processor (CPU) 71 determines that there is no vehicle, moves to Step S105, and outputs a high-beam-mode signal. In response to the signal, illuminating operation is performed with the high-beam lamp by the headlamp controller 30 (high beam is emitted).

In such a manner, by the processes of Steps S102 and S105, the headlamp as the illuminating device for a vehicle is controlled optimally in various travel environments, so that visibility of the driver can be improved. For example, in an environment with the small number of road lights, the high-beam lamp is used. When a preceding or oncoming vehicle exists, the low-beam lamp is used to prevent the driver of the other vehicle from being dazzled.

Though switching between the headlamps 10 and 20 is controlled as the processes in Steps S102 and S105, light distribution of the headlamps 10 and 20 may be controlled. Alternatively, both of the control of switching between the headlamps 10 and 20 and the control of light distribution may be performed. Specifically, at least one of the switching between the headlamps 10 and 20 of the vehicle and the light distribution is controlled on the basis of a determination result of the environment in which the vehicle travels and a determination result of the presence or absence of another vehicle. The “switching between the headlamps” at the time of controlling at least one of the switching between headlamps 10 and 20 of the vehicle and the light distribution denotes switching between the low-beam lamp and the high-beam lamp, and the “light distribution” denotes a change in the illumination distance and direction or adjustment of an illumination amount (lighting control) by changing the optical axis of light emitted. Those operations can be performed by using an adaptive front-lighting system (AFS) or an optical axis adjusting mechanism (auto leveling system) introduced in recent years.

At the time of controlling one of the switching between the headlamps 10 and 20 of the vehicle and the light distribution, the arithmetic processor (CPU) 71 may change the control speeds (switching speed and light distribution speed) on the basis of the travel information (vehicle speed, steering angle, yaw rate, inclination of the vehicle, and the like) of the vehicle. Concretely, the time required to switch the headlamp may be varied by using the information indicative of the vehicle states from the vehicle speed sensor 48, the steering angle sensor 49, the vehicle state sensor 50, and the like. For example, the headlamp is switched swiftly when the vehicle travels at high speed, and is switched slowly when the vehicle travels on a curved road or the like. The operation is preferable to optimize the control speed of the headlamps of the vehicle.

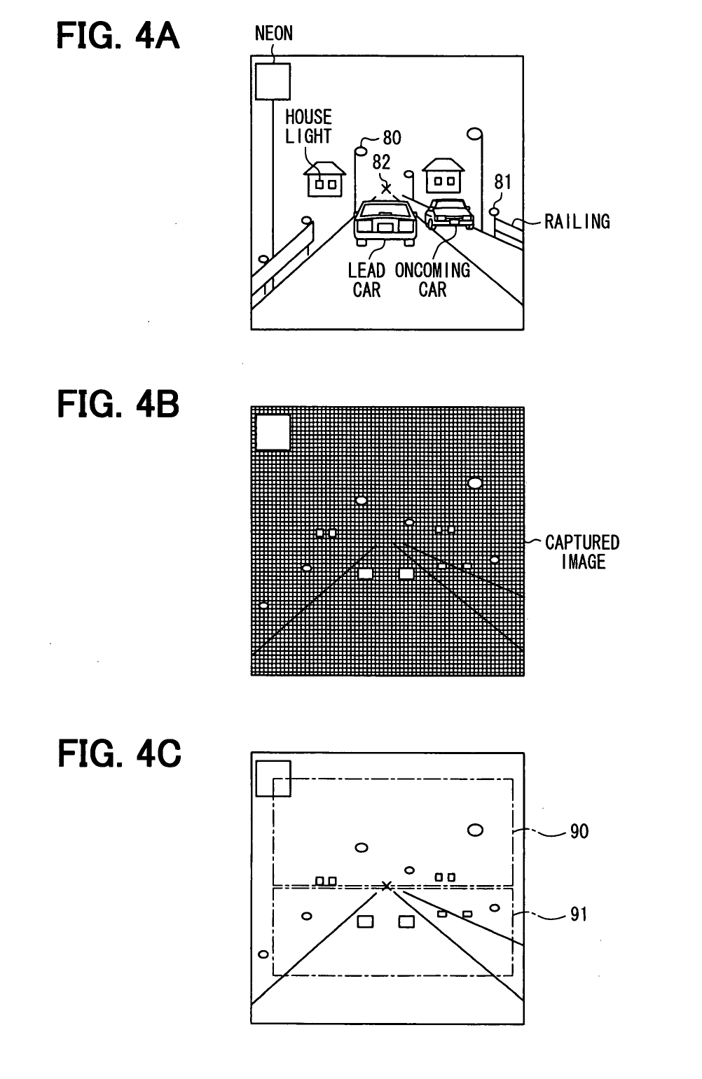

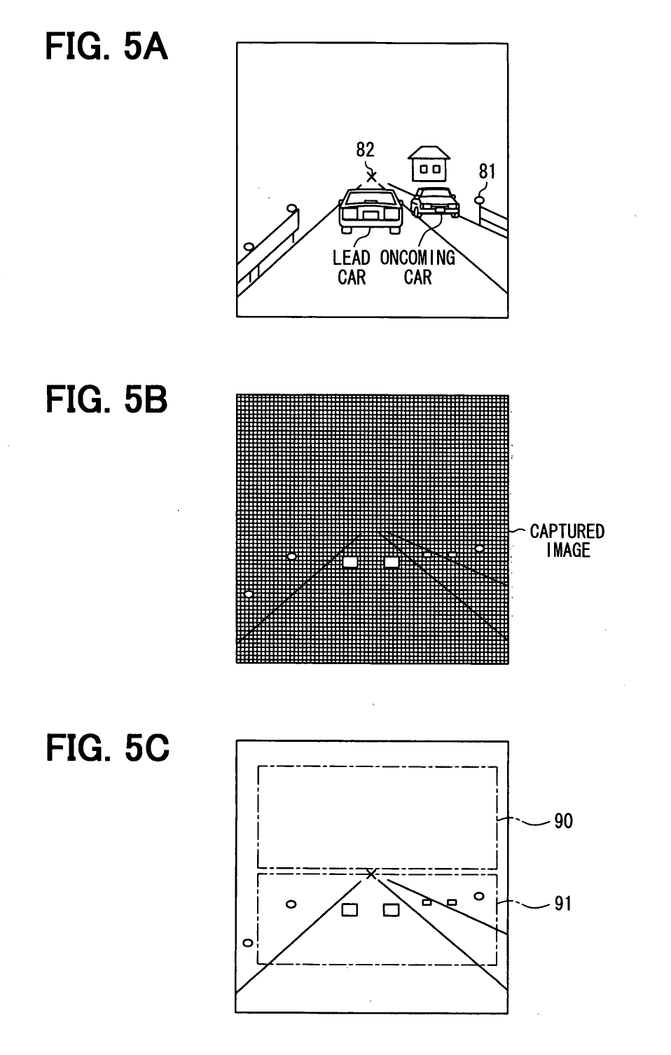

The action will now be described by using image examples of FIGS. 4A to 4C and FIGS. 5A to 5C.

FIGS. 4A to 4C and FIGS. 5A to 5C show image examples when the in-vehicle front environment detector (such as the imaging device 62) is mounted in the front part of an inside rear view mirror (on the front wind shield side).

FIGS. 4A and 4C and FIGS. 5A and 5C are explanatory images schematically drawn for interpretation. FIGS. 4B and 5B are images captured by the image sensor unit 60 in FIG. 2 when the mounting angle (depression angle) of the imaging device 62 of the in-vehicle front environment detector 44 is 0, the radius of curvature of a road is 0, and the gradient of the road is 0.

Generally, in the mounting position, the height is about 1.5 m. In FIG. 4A, a light (road light) 80 on a road is mounted at a height of 8 m or higher, and a visual guidance sign 81 is mounted at a height of about 1 m. Therefore, there is high probability that the road light 80 exists above a vanishing point 82 of the road in the image and the visual guidance sign 81 exists below the vanishing point 82. Consequently, a range for determining whether the travel environment is light or not (a brightness determination range 90 in FIG. 4C) in Step S101 in FIG. 3 is set above the vanishing point 82 in FIG. 4A. Since the vehicle lighting is often mounted at about 0.5 m to 1.2 m (0.35 m to 2.1 m in the safety standard), a vehicle light search range 91 for searching for a vehicle light is set below the vanishing point 82. The ranges 90 and 91 may be finely adjusted in the vertical direction in accordance with the mounting height and the angle (depression angle) of the imaging device 62 in the in-vehicle front environment detector 44.

By the process of Step S101 in FIG. 3, the travel environment shown in FIGS. 4A to 4C is determined as “light travel environment” because a plurality of light sources are extracted in the brightness determination range 90. The travel environment shown in FIGS. 5A to 5C is determined as “dark travel environment” since no light source exists in the brightness determination range 90.

By the processes in Steps S103, S106, and S108 in FIG. 3, the presence or absence of a vehicle in the vehicle light search range 91 in FIGS. 4C and 5C is determined. On the basis of the determination result, at least one of the switching of the headlamp and the light distribution is controlled.

The ranges 90 and 91 in FIGS. 4C and 5C are preset on the basis of the road parameters (a method of detecting a traffic lane on an image may be added) and the illumination range of the headlamps. The arithmetic processor (CPU) 71 in the in-vehicle front environment detector 44 makes fine adjustment at all times by the vehicle speed sensor 48, the steering angle sensor 49, the vehicle state sensor 50, the road information provider 51, and the like in FIG. 1. Concretely, the arithmetic processor (CPU) 71 obtains signals from the devices and changes the ranges 90 and 91 on the basis of the travel information (at least one of the vehicle speed, steering angle, yaw rate, gradient of the vehicle, and the road information from the road information provider 51) of the vehicle in the process of Step S101 in FIG. 3.

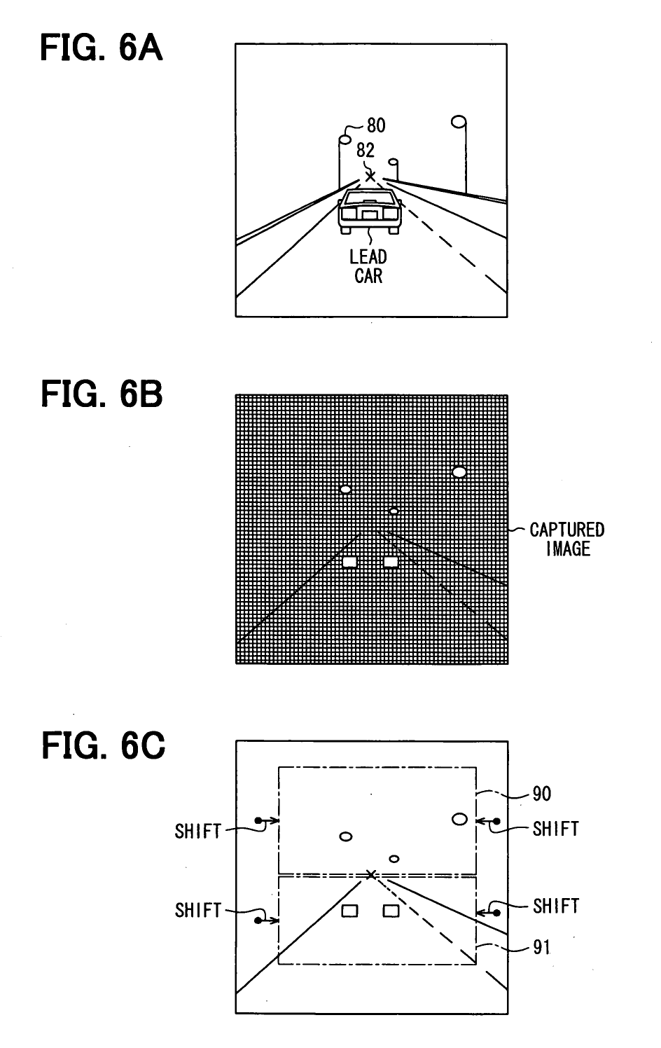

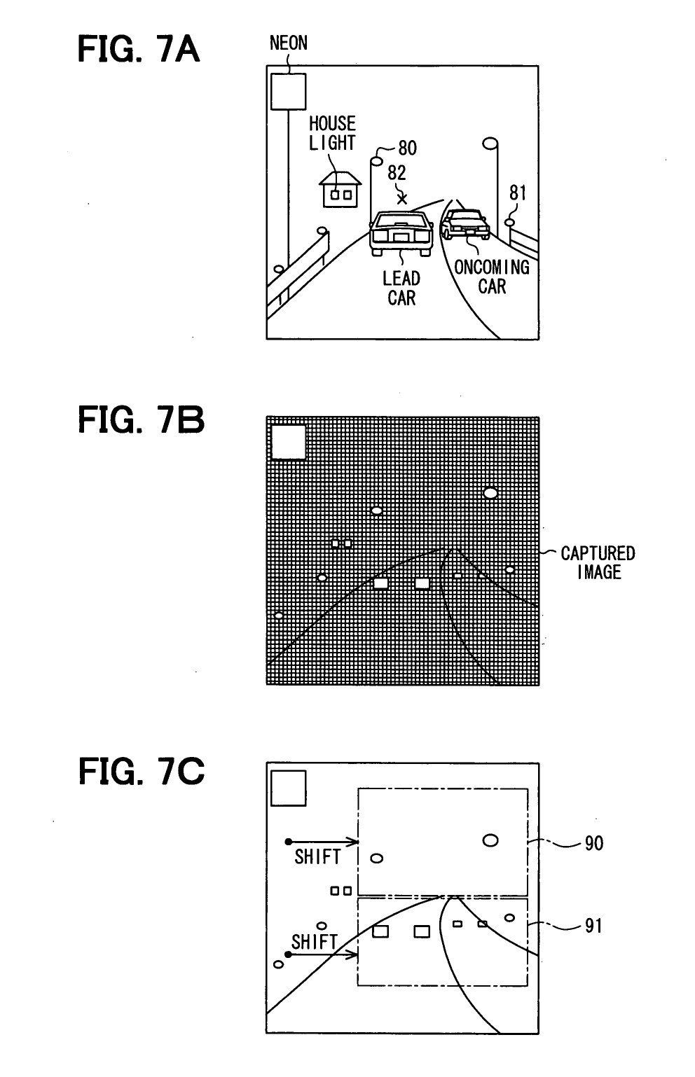

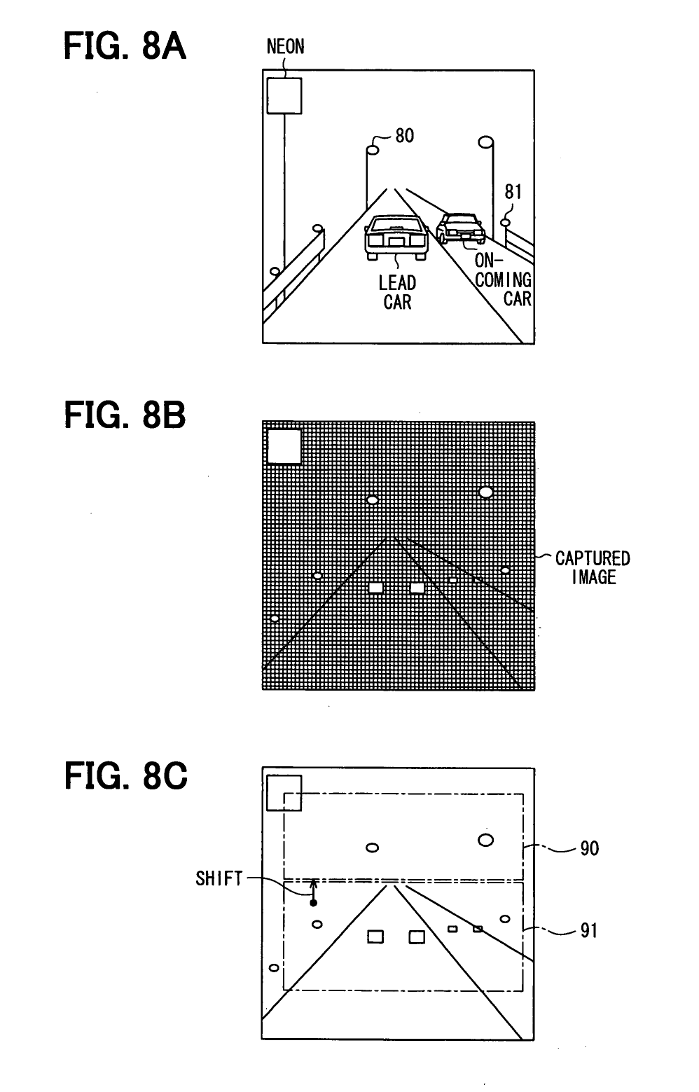

For example, as shown in FIGS. 6A to 6C, when the vehicle speed is high, the ranges 90 and 91 are narrowed (FIGS. 6A to 6C show a state in which the vehicle travels on an expressway at higher speed as compared with the speed when the vehicle travels in a city as shown in FIGS. 4A to 4C, and the width of the brightness determination range 90 and the vehicle light search range 91 is narrowed). This operation is performed in consideration of the fact that the range can be narrowed because the curve of a road on which the vehicle can travel at high speed is gentle. As shown in FIGS. 7A to 7C, the ranges 90 and 91 are shifted to the steering side on the basis of the steering angle, the yaw rate, or the road information (FIGS. 7A to 7C show a state where the vehicle travels on a road curved to the right and the left ends of the brightness determination range 90 and the vehicle light search range 91 are shifted to the right as compared with the state where the vehicle travels on a linear road shown in FIGS. 4A to 4C). As shown in FIGS. 8A to 8C, when the gradient of the vehicle is large, the range 90 is shifted in the vertical direction (FIGS. 8A to 8C show a state where the vehicle travels on an uphill not a flat road shown in FIGS. 4A to 4C, the height of the brightness determination range 90 is reduced, and the height of the vehicle light search range 91 is increased). When the situations are mixed, for example, when the vehicle travels at high speed on an uphill, the width of the ranges 90 and 91 is reduced, and the range 90 is shifted upward.

The above operations are preferable for optimization.

The range 91 for determining the presence or absence of another vehicle will be mentioned. When the light amount characteristics of vehicle lights such as the headlamp and the tail lamp in a distance from another vehicle are considered and the size and symmetry of light sources extracted from an image are provided, the upper and lower limits of the range 91 can be also finely adjusted from the distance calculated from the interval of the light sources (estimated distance). For example, when the brightness is high, it is estimated that the distance is short, and the upper and lower limits are finely adjusted.

The in-vehicle front environment detector 44 in FIG. 1 sets so that the headlamps are turned on only in a state where the engine operates in accordance with the start signal from the engine starter 46. The setting produces an effect of preventing exhaustion of the battery even when the engine is turned off in the automatic mode. The in-vehicle front environment detector 44 turns on the headlamps when it rains even in daytime in accordance with the wiping speed signal from the wiper device 47. It produces an effect of safety by letting the other vehicles know the existence of the vehicle.

By the embodiment, the following effects can be obtained.

(1) In the configuration of the in-vehicle front environment detector 44, the arithmetic processor (CPU) 71 processes an image obtained by the imaging device 62, determines the brightness of the environment in which the vehicle travels and, when it is determined that the environment in which the vehicle travels is dark, processes the image obtained by the imaging device 62 to determine the presence or absence of another vehicle. Therefore, considering the brightness of the environment in which the vehicle travels (the night visibility of the driver), whether the road environment requires the vehicle detection and determination or not is determined. When the vehicle detection and determination is necessary, the vehicle detection can be performed. That is, necessity of determining the presence or absence of other vehicles can be easily determined. Without using two optical systems (i.e., without increasing the cost) and without performing high-speed imaging or high-level signal process, vehicle detection can be performed easily as necessary. Further, without using high-level image analyzing process for extracting a preceding vehicle and an oncoming vehicle from a captured image, vehicle detection can be performed easily as necessary.

Particularly, the range 90 for determining the brightness of the travel environment and the range 91 for determining the presence or absence of another vehicle are predetermined ranges on a captured image. Consequently, as compared with the case of making determination in the whole image range, the arithmetic process load can be lessened.

(2) The processor 71 is employed to appropriately control the selective switching and/or the intensity control of the headlamps 10, 20 based on the detection result of the brightness and other vehicles.

(3) The processor 71 is employed to appropriately control the headlamps 10, 20 according to the vehicle information such as the vehicle speed, the steering angle, the yaw rate, the vehicle body angle (inclination), and the information from an outside information source. For example, the vehicle speed may be correlated with the detection area in the image, the steering angle may be correlated with the detection area, and the vehicle body angle may be correlated with the detection area.

Although the present invention has been fully described in connection with the preferred embodiment thereof with reference to the accompanying drawings, it is to be noted that various changes and modifications will become apparent to those skilled in the art.

That is, signals from the vehicle speed sensor 48, the steering angle sensor 49, the vehicle state sensor 50, and the road information provider 51 may be totally considered for controlling the headlamps 10, 20 in addition to the signals from the in-vehicle front environment detector 44. In other words, the vehicle information in addition to the brightness and other vehicle is used to control the headlamps 10, 20.

For example, the automatic mode may only be used for the vehicle speed of 50 km/h or more. Or, the low beam may only be used for a hill climb. Or, the optical axis of the headlamps 10, 20 may be swiveled according to the steering angle or the like when the vehicle is turning right or left.

Such changes and modifications are to be understood as being within the scope of the present invention as defined by the appended claims.

What is claimed is:

1. A front environment detection apparatus for use in a subject vehicle comprising:
an imaging unit for imaging a front view in a traveling direction of the subject vehicle;
a light detector for detecting brightness of a field where the subject vehicle is traveling based on a processing of an image of the front view acquired by the imaging unit; and
a field detector for detecting an other vehicle in the field based on the image of the front view when brightness of the field detected by the light detector is in a predetermined range.

2. A front lighting apparatus for use in a subject vehicle comprising:
an imaging unit for imaging a front view in a traveling direction of the subject vehicle;
a light detector for detecting brightness of a field where the subject vehicle is traveling based on a processing of an image of the front view acquired by the imaging unit;
a field detector for detecting an other vehicle in the field based on the image of the front view when brightness of the field detected by the light detector is in a predetermined range; and
a headlamp controller for controlling a headlamp of the subject vehicle in terms of at least one of headlamp selection and headlamp lighting distribution based on a detection result of the light detector and the field detector.

3. The front environment detection apparatus as in claim 1,
wherein the light detector calculates an averaged gradation level of a predetermined area in the image of the front view for determining brightness of the field based on a comparison with a threshold of brightness.

4. The front environment detection apparatus as in claim 1,
wherein the light detector calculates a number of light sources in a predetermined area of the image of the front view for determining brightness of the field based on a comparison with a threshold.

5. The front environment detection apparatus as in claim 1,
wherein the light detector extracts and traces an intensive light source in a predetermined area in the image of the front view for detecting an oncoming vehicle.

6. The front environment detection apparatus as in claim 1,
wherein the light detector extracts and traces a horizontally-symmetrical light source in a predetermined area in the image of the front view for detecting an oncoming vehicle.

7. The front environment detection apparatus as in claim 1,
wherein the light detector extracts and traces a light source having a predetermined gradation level in a predetermined area in the image of the front view for detecting an oncoming vehicle.

8. The front environment detection apparatus as in claim 3,
wherein the predetermined area in the image of the front view is varied according to vehicle information of the subject vehicle.

9. The front environment detection apparatus as in claim 8,
wherein at least one of a vehicle speed, a steering angle, a yew rate, a vehicle body angle, and a road information from a road information provider is used as the vehicle information.

10. The front environment detection apparatus as in claim 5,
wherein a trace time for tracing the light source to detect the other vehicle is varied based on the vehicle information of the subject vehicle.

11. The front environment detection apparatus as in claim 5,
wherein the other vehicle is set to be detected in an attempt for detecting the other vehicle based on the vehicle information of the subject vehicle when tracing of the light source is unsuccessful during a trace time for tracing the light source.

12. The front lighting apparatus as in claim 2,
wherein a speed of controlling the headlamp of the subject vehicle in terms of at least one of the headlamp selection and the headlamp lighting distribution is varied based on the vehicle information of the subject vehicle.
